(19) United States
(12) Patent Application Publication
(10) Pub. No.: US 2005/0063169 A1
(43) Pub. Date: Mar. 24, 2005

(54) Lighting unit with light source and optical waveguide

(75) Inventor: Andreas Erber, Ostfildern (DE)

Correspondence Address: WARN, HOFFMANN, MILLER & LALONE, .P.C, PO BOX 70098, ROCHESTER HILLS, MI, 48307, US

(73) Assignee: Schefenacker Vision Systems Germany GmbH & Co. KG, Esslingen (DE)

(21) Appl. No.: 10/913,718

(22) Filed: Aug. 6, 2004

(30) Foreign Application Priority Data
Aug. 7, 2003 (DE) 103 36 162.6

(51) Int. Cl. F21V 7/04

(52) U.S. Cl. 362/31

(57) ABSTRACT

The invention relates to a lighting unit with at least one light source and at least one optical waveguide following the light source, said waveguide having at least one light transmitting surface. To this end, the lighting unit has at least one reflector. In addition, at least one light transmitting surface of the optical waveguide faces the reflector. A lighting unit with an optical waveguide which has a large illuminated area and requires only a small space is provided.

### CROSS-REFERENCE TO RELATED APPLICATION

This application claims priority to German Patent Application No. 103 36 162.6 filed on Aug. 7, 2003.

### FIELD OF THE INVENTION

The invention relates to a lighting unit with at least one light source and at least one optical waveguide following the light source, said waveguide having at least one light transmitting surface.

### BACKGROUND OF THE INVENTION

Such a lighting unit is known from DE 199 30 461 A1. To achieve a large illuminated area, this lighting unit includes a light source followed by two optical waveguides arranged in series. This construction requires a large amount of space.

### SUMMARY OF THE INVENTION

The present invention is based on the object of developing a lighting unit with an optical waveguide which has a large illuminated area and requires only a small space.

This object is attained with the features of the main claim. To this end, the lighting unit has at least one reflector. In addition, at least one light transmitting surface of the optical waveguide faces the reflector.

Light rays emitted by the light source are directed through the optical waveguide. The light rays exit the optical waveguide at least through the light transmitting surface facing the reflector. They are reflected at the reflector and emitted into the environment. The area illuminated by the lighting unit, for example when the lighting unit is employed as a headlight, is large. At the same time, only a small space is required for the lighting unit as a result of the redirection of the light rays. Moreover, the light source can be mounted in an easily accessible location on the lighting unit.

The light source can be a light-emitting diode. Light-emitting diodes are luminescence diodes that are used as complete units with integrated optical waveguide and light distribution devices, for example in motor vehicles. The light-emitting diodes can be implemented as individual light sources, but multiple light-emitting diodes can also be combined into a unit, for example a taillight unit. In such a light-emitting diode unit that is a design element of the vehicle, the light-emitting diodes can, for example, be cast together.

The reflector can, for example, be flat, curved in one or more axes, parabolic or paraboloidal. Parallel light rays striking the reflector intersect at a focal line in the case of a parabolic reflector, while in the case of a paraboloidal reflector they intersect at a focal point.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a lighting unit with externally located light source;

FIG. 2 is a lighting unit from FIG. 1 without housing;

FIG. 3 is a lighting unit with a two-part reflector;

FIG. 4 is a lighting unit with a paraboloidal reflector; and

FIG. 5 is a front view of the lighting unit from FIG. 4.

### DETAILED DESCRIPTION OF THE PREFERRED EMBODIMENTS

The following description of the preferred embodiment(s) is merely exemplary in nature and is in no way intended to limit the invention, its application, or uses.

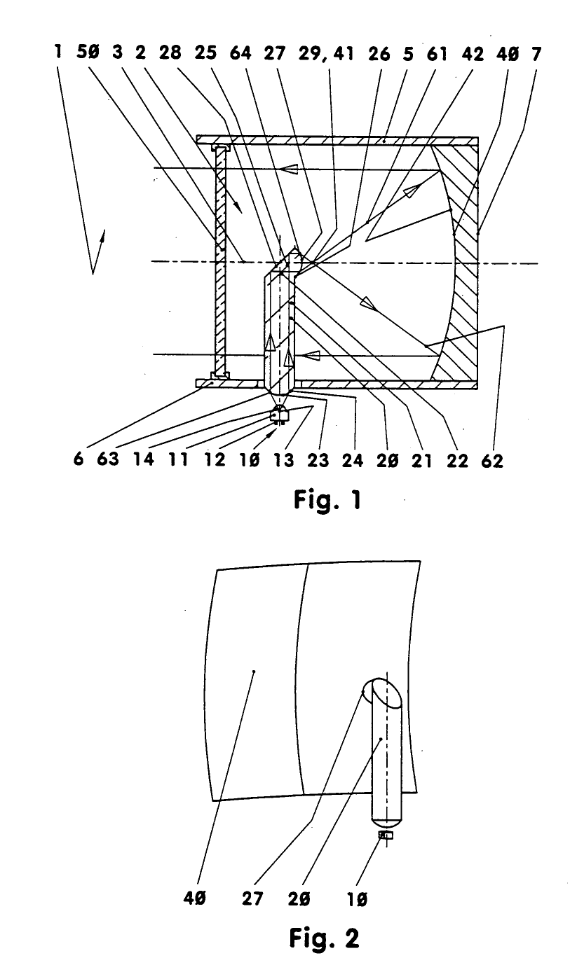

FIGS. 1 and 2 show a lighting unit, for example a headlight for a motor vehicle. The lighting unit includes a housing on which are arranged a light source, an optical waveguide, a reflector and a diffusion plate. The optical waveguide that follows the light source radiates the light emitted by the light source toward the reflector, and the reflector reflects the light through the diffusion plate into the environment.

The length of the lighting unit corresponds approximately to its height. Its width perpendicular to the plane of the drawing in FIG. 1 is approximately 80% of its length; compared with FIG. 2.

The light source is, for example, attached to the outside of the housing base, in a manner not shown in detail in FIG. 1. It is a light-emitting diode, for example. This consists of electronic components, e.g. a light-emitting chip, a base and at least two contacts connected to the chip. At least the light-emitting chip is enclosed by an electronics housing that faces in the direction of the housing base.

In addition, in a manner not shown in detail in FIG. 1, the optical waveguide is attached to the housing base. The optical waveguide is a rod-shaped transparent glass or plastic body, made for example of PMMA or PMMI, which projects into the housing from outside. It has a cylindrical section and a section that is offset in the direction of the reflector. The length of the optical waveguide is approximately five times the diameter of its cylindrical section. The end face of the cylindrical section that projects out of the housing includes a convex surface. Its separation from the light-emitting diode is approximately one third of the diameter of the cylindrical section. The offset section has the shape of a wedge-shaped prism in the cross-sectional representation in FIG. 1. The base surface of the prism that lies in the plane of the drawing is a right isosceles triangle. One imaginary leg surface forms the transition between the cylindrical section and the prism. The second leg surface includes a convex surface. The hypotenuse surface subtends an angle of 45 degrees with an imaginary plane tangential to the cylindrical section. The optical waveguide is arranged in the lighting unit such that the convex surface is located symmetrically with respect to the horizontal center plane. This horizontal center plane lies normal to the plane of the drawing in FIG. 1.

The reflector is, for example, arranged symmetrically with respect to the horizontal center plane on the inner side of an end face of the housing. It has the shape of a cylindrical parabolic surface that is open toward the optical waveguide, compare with FIG. 2. The reflector thus encloses the optical waveguide. The distance between the focal line of the reflector and the reflector is approximately 93% of the distance between the convex surface and the reflector.

The surface of the reflector facing the optical waveguide is a reflective surface, which for example has a high degree of optical reflectivity. To this end, the reflector can be coated over some or all of its area, for example.

The diffusion plate is arranged in the housing opposite the reflector. The diffusion plate is, for example, a glass plate arranged normal to the horizontal center plane that protects the lighting unit from such influences as contamination and damage.

In place of the convex surface, the cylindrical section can also, for example, have a concave cavity in the shape of a section of a sphere. The light source is then arranged at this cavity, for example.

In producing the lighting unit, the light-emitting diode and the optical waveguide can be manufactured as one piece. The light-emitting diode is then molded-in in an injection mold to produce the optical waveguide, for example. A homogeneous body results, from which, e.g., the contacts project on one side.

In the operation of the lighting units shown in FIGS. 1 and 2, light rays are emitted from the light-emitting diode toward the convex surface of the optical waveguide. The convex surface acts as a converging lens through which the light rays emitted from the light-emitting diode enter the optical waveguide. When the light rays pass from the optically less dense medium of the environment into the optically denser medium of the optical waveguide, the light rays are refracted toward the perpendicular at the point of incidence. They then travel approximately parallel in the optical waveguide, for example. At the hypotenuse surface, they are incident at an angle of, for example, 45 degrees. This angle is greater than the threshold angle of total internal reflection at the interface between the optical waveguide and the environment. This threshold angle is 38 degrees for PMMI and 42 degrees for PMMA, for example. The light rays striking the hypotenuse surface are totally reflected at the hypotenuse surface and are directed, for example, parallel to one another toward the convex surface. This convex surface is a light transmitting surface. It acts as a converging lens. The light rays striking the convex surface are refracted away from the perpendicular at the point of incidence as they cross the interface from the optically denser medium of the optical waveguide to the interior space of the lighting unit, which for example communicates with the surrounding air. They are, for example, focused to a focal point and then diverge toward the reflector. The focal point of the converging lens is located, for example, on the focal line of the reflector. Light rays striking the reflector are then reflected such that they are directed toward the diffusion plate.

When this lighting unit is used, for example as a motor vehicle headlight, the street in front of the motor vehicle is illuminated uniformly and over a large area. Toward the edge, there is a gradual transition to the unilluminated area, for example due to scattered light reflected at the outer areas of the reflector.

The reflector can also have nonreflective areas. In this way, for example, an asymmetrical illuminated area for the lighting unit can be created.

The light transmitting surface facing the reflector can also be a flat surface, a diverging lens, etc.

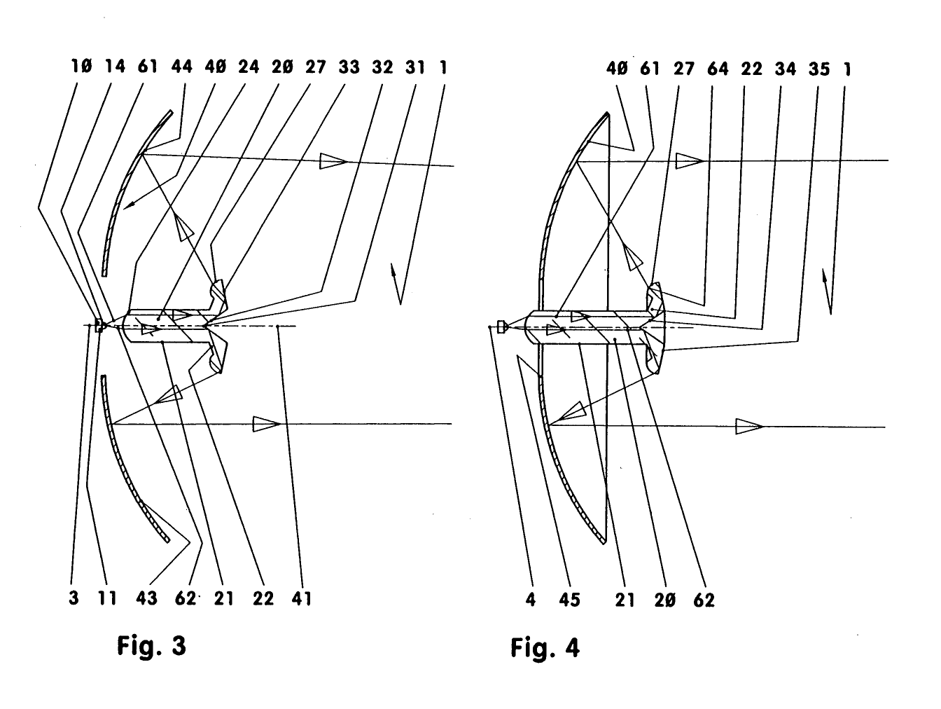

FIG. 3 shows a lighting unit whose length is approximately one third of its height. This lighting unit also includes a light source and an optical waveguide following said light source. The reflector includes a lower reflector part and an upper reflector part that is a mirror image thereof, whose plane of symmetry is the horizontal center plane of the lighting unit. Both reflector parts have for example the shape of sections of a cylindrical parabolic surface. The distance of the two reflector parts from one another is, for example, approximately one quarter of the overall height of the reflector.

The light source is for example arranged on the horizontal center plan of the lighting unit such that the base lies on an imaginary plane joining the two reflector parts and the electronics housing extends in the direction of the opening of the reflector.

The optical waveguide has a cylindrical section and two offset sections that are arranged as mirror images of one another relative to the horizontal center plane of the lighting unit. The two sections have a prism-shaped cross-section as projected onto the plane of the drawing in FIG. 3. They are separated from one another by a horizontal groove. The length of the offset sections is, for example, approximately half the length of the optical waveguide. The offset sections have two outer surfaces which together enclose an obtuse angle. Both the light transmission surface facing the light source and the light transmission surface facing the reflector are convex surfaces which act as converging lenses. Together, the surfaces of the optical waveguide facing the groove enclose an angle of approximately 90 degrees. The optical waveguide is arranged with respect to the reflector such that, for example, the distance from the light transmission surfaces to the reflector is less than the distance from the reflector to its focal line.

In the operation of the lighting unit, the light rays emitted from the light source pass through the converging lens into the optical waveguide. They are totally internally reflected twice in the offset sections at the outer surfaces and emerge from the converging lenses in the direction of the reflector. Upon emerging from the optical waveguide through the light transmitting surfaces, the light rays are refracted away from the perpendicular. After reflection at the reflector, they are then radiated toward the diffusion plate not shown here toward the environment.

The area illuminated by this lighting unit has two bright areas, between which lies a darker central region which, for example, lies parallel to the front edge of the motor vehicle.

The two offset sections of the optical waveguide, and/or the two reflector parts can also have different shapes. Thus, for example, the upper reflector part can have a greater curvature than the lower reflector part. The light rays striking the reflector are then deflected downward, for example. The field illuminated on the street is then asymmetrical, for example.

In an elongated embodiment of the offset sections, the two sections extend further toward the lower reflector part or the upper reflector part, and the installation length of the lighting unit can be shortened and/or the radius of curvature of the reflector can be increased. In this way, for example, it is possible to build an extremely short headlight.

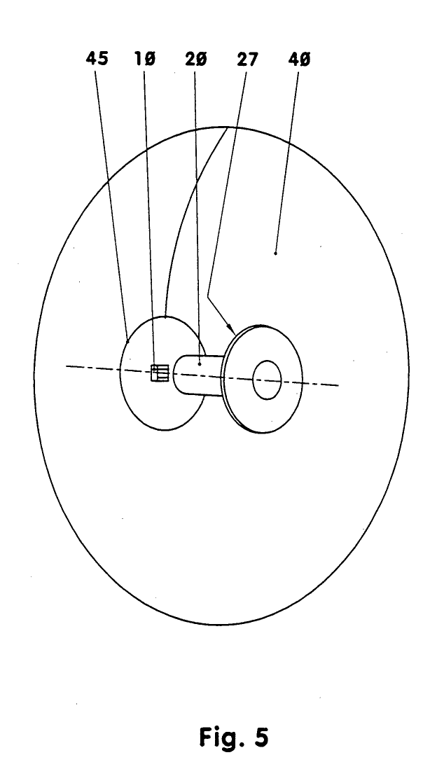

FIGS. 4 and 5 show a lighting unit whose reflector has the shape of a paraboloid of rotation. The length of this lighting unit is approximately 40% of its diameter. The reflector has a central hole whose diameter is approximately one quarter of the diameter of the reflector. The optical waveguide extends through this hole into the reflector. The light source is, for example, arranged outside an imaginary plane that closes the hole in the reflector. The light source has, for example, a high light intensity and is cooled by a cooling device to remove heat. It is easily accessible for maintenance and replacement.

The optical waveguide is rotationally symmetrical about the center line of the lighting unit. It includes a cylindrical section and an offset section. The offset section has two mutually concentric end faces facing away from the reflector, which together enclose an obtuse angle. The inner end face, whose diameter corresponds to the diameter of the cylindrical section, has the shape of the tip of an obtuse cone. It is mirror-finished, for example.

The side of the offset section facing the reflector in FIGS. 4 and 5 is the emergent surface. This is an annular surface that is domed toward the reflector.

Light rays emitted by the light source are refracted on passing through the converging lens such that, for example, they are directed parallel to one another within the optical waveguide. They are reflected at the inner end face and are refracted away from the perpendicular at the point of incidence at the light transmitting surface. When they strike the reflector, the light rays are redirected and radiated into the environment.

The area illuminated by this lighting unit is large and has an approximately uniform brightness. Of course, the shape of the illuminated area can be altered by the shape of the reflector, the shape and position of the optical waveguide, etc. Moreover, additional areas can be provided in the reflector that are, for example, raised toward the optical waveguide. In this way, for example, individual portions of the illuminated area can be more intensely illuminated, for example to mark the lateral edges of the motor vehicle.

The optical waveguide can also have a section that is conical, pyramidal, arched, etc., instead of a cylindrical section. Within this section, the light emitted by the light source can then be totally internally reflected one or more times, or can, for example, be reflected at an outer surface that is mirror-finished in certain areas.

The surface of the optical waveguide can also be completely mirror-finished except for the light transmitting surfaces.

Multiple light sources, multiple optical waveguides and/or one or more reflectors can be arranged in one lighting unit. In this way, for example, a large area in front of a vehicle can be illuminated.

The description of the invention is merely exemplary in nature and, thus, variations that do not depart from the gist of the invention are intended to be within the scope of the invention. Such variations are not to be regarded as a departure from the spirit and scope of the invention.

1. A lighting unit comprising:
at least one light source;
at least one reflector; and
at least one optical waveguide following the light source, said optical waveguide having at least one light transmitting surface, and said at least one light transmitting surface of the optical waveguide facing the reflector.

2. The lighting unit in accordance with claim 1, wherein the optical waveguide is at least partially enclosed by the reflector.

3. The lighting unit in accordance with claim 1, wherein the light source is not enclosed by the reflector.

4. The lighting unit in accordance with claim 1, wherein the light source is a light-emitting diode.

5. The lighting unit in accordance with claim 4, wherein the optical waveguide is molded onto the light-emitting diode.

6. The lighting unit in accordance with claim 1, wherein the reflector has the shape of a paraboloid of rotation.

7. The lighting unit in accordance with claim 1, wherein said at least one light transmitting surface includes at least a portion of a converging lens.

8. The lighting unit in accordance with claim 1, wherein the optical waveguide has a surface that is mirror-finished at least in certain areas other than the light transmission surfaces.

9. The lighting unit in accordance with claim 1, wherein the reflector has at least one nonreflective area.

10. The lighting unit in accordance with claim 1, wherein the reflector has at least one area that is raised toward the optical waveguide.
